(19) United States
(12) Patent Application Publication
(10) Pub. No.: US 2005/0142965 A1
(43) Pub. Date: Jun. 30, 2005

(54) Surface charge manipulation for improved fluid intake rates of absorbent composites

(75) Inventor: Jeffrey Mark LaFortune, Neenah, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/747,924

(22) Filed: Dec. 29, 2003

(51) Int. Cl. B32B 3/00; B32B 5/02; B32B 9/00; B32B 5/16; B32B 5/18; D04H 3/00; D04H 13/00

(52) U.S. Cl. 442/59; 442/74; 442/76; 442/118; 442/121

(57) ABSTRACT

This invention describes a novel means for improving fluid intake rates in disposable absorbent composites by altering the surface charge on the components of such composites through utilization of surface charge treatments (i.e., charge modifiers). The composite components contemplated for the invention may include, but are not limited to, conventional superabsorbent particles (SAP) and fluff fibers (fluff). The surface charge modifiers of the present invention are specifically selected to achieve an ionically (i.e., electrically) generated repulsive force between the individual composite components in the presence of an insulting fluid. This active repulsion between composite components creates a condition in the composite conducive to superabsorbent swelling and generation of void volume and flow channels, thus improving the fluid intake rate.

### BACKGROUND

Conventional disposable articles typically include an absorbent composite, also sometimes referred to as an absorbent core or absorbent structure, formed by air-forming, air-laying or other known forming technique for uptaking and retaining bodily exudates. For example, the manufacture of such an absorbent composite may begin by fiberizing a fibrous sheet of hydrophilic material in a fiberizer or other shredding or comminuting device to form discrete fibers. In addition, particles or fibers of superabsorbent material, which are water insoluble, water swellable and capable of absorbing up to at least about ten times their weight in 0.9 weight percent sodium chloride solution (saline solution), are mixed with the discrete fibers. The hydrophilic fibers and superabsorbent material are then entrained in an air stream and directed to a foraminous forming surface upon which the fibers and superabsorbent material are deposited and accumulated to form the absorbent composite.

There is a continuing effort by absorbent composite manufacturers to improve the liquid intake performance of absorbent composites, especially at high levels of composite saturation, to thereby reduce the tendency of such a composite to leak as it becomes increasingly saturated during use, particularly where the composite is subjected to repeated liquid insults before being discarded. This has become a bigger challenge as recent efforts in commercial absorbent composite design have generally focused on using higher concentrations of superabsorbent material and less fiber to make the absorbent composite thinner and denser. However, notwithstanding the increase in total absorbent capacity obtained by increasing the concentration of superabsorbent material, such absorbent composites may still nevertheless leak during use. Such leakage may in part be the result of the overall composite having an insufficient intake rate (i.e., the rate at which a liquid insult can be taken into and entrained within the composite for subsequent absorption by the superabsorbent material) due to lack of available void volume.

Therefore, there is a need for a means to generate an improvement in fluid flow channels and void volume (and thus fluid intake rates) within an absorbent composite upon fluid insult without resorting to complex, capital intensive absorbent fabrication processes or additional non-absorbent binder fiber components. Such means should be compatible with conventional, low cost, efficient air-forming equipment that is widely used in the industry and integrated in the disposable absorbent article manufacturing process.

### SUMMARY OF INVENTION

This invention describes a novel means for improving fluid intake rates in disposable absorbent composites by altering the surface charge on the components of such composites through utilization of surface charge treatments (i.e., charge modifiers). The composite components contemplated for the invention may include, but are not limited to, conventional superabsorbent particles (SAP) and fluff fibers (fluff). The surface charge modifiers of the present invention are specifically selected to achieve an ionically (i.e., electrically) generated repulsive force between the individual composite components in the presence of an insulting fluid. This active repulsion between composite components creates a condition in the composite conducive to superabsorbent swelling and generation of void volume and flow channels, thus improving the fluid intake rate.

In general, an absorbent composite according to one example of the present invention comprises an improved fluid intake performance obtained by increasing the permeability, flow channels, and void volume of an SAP/fluff composite without resorting to more complex and costly methods. More particularly, the surface charge treatments of the present invention should suitably be selected to maximize the repulsive forces between individual composite components to generate void volume and increase flow channels. The repulsive environment within the composite reduces any inherent physical or chemical material binding tendencies and preferentially provides a motive force to facilitate reduced interactions. Reduced interactions allow for less inhibited swelling, increased void volume and improved ability for fluid to quickly enter the composite. When components within the composite are less restrained and are allowed to freely separate, the composite will preferentially (via repulsive forces between composite components) seek the greatest amount of open void volume and fluid channels upon swelling.

It should be understood that numerous means can be engaged for modifying the surface charge of components within a composite without departing from the scope of the invention. For example, such means could include, but are not limited to, chemicals (e.g., oxidation, reduction, hydrolysis, polymerization, and addition reactions); coatings; and electron beam, radiation, and corona treatments. For the present invention, the surface charge/ionic interactions between composite components provide a condition that delivers the effect of increasing the fluid intake rate of a composite as measured using the test methods described herein. When modifying the surface charge, the means selected should both form the desired combination of cationic or anionic surface charges when composite components are exposed to an aqueous medium, and should retain the resulting cationic or anionic charge on the surface of the component. In one example, each of the components is subjected to a surface charge treatment to improve the overall composite fluid intake rate.

It should be further understood that the surface charge properties inherent in each of the individual composite components may provide a desirable degree of functionality for improved void volume generation. Under such circumstances, additional surface charge treatments may not be required for at least one of the components. Therefore, less than all of the components would require surface charge treatments for improving the overall composite fluid intake rate.

### DEFINITIONS

Within the context of this specification, each term or phrase below will include the following meaning or meanings:

“Air-Formed” refers to absorbent structures/process that do not contain any activated binder material, and as such, could include other absorbent materials such as pulp fiber and high absorbency material. Accordingly, airformed absorbent structures will generally have hydrogen bonding and fiber entanglement as the primary means of maintaining the integrity of the absorbent structure.

“Air-Laid” refers to an absorbent structure/process that has a quantity of binder material such as thermoplastic fibers added to a mixture of other absorbent materials, such as a quantity of absorbent fibers and a quantity of superabsorbent material, to provide an absorbent matrix. It should be noted that the absorbent mixture (for example, the quantity of absorbent fibers and quantity of superabsorbent material) and the quantity of binder material may be provided in a homogeneous mixture; or the quantity of binder material may be added to the absorbent mixture in a stratified configuration. The binder material is then activated to bond the resultant absorbent matrix together.

“Bonded-Carded” refers to webs that are made from fibers which are sent through a combing or carding unit, which separates or breaks apart and aligns the fibers in the machine direction to form a generally machine direction-oriented fibrous non-woven web. This material may be bonded together by methods that include point bonding, through air bonding, ultrasonic bonding, adhesive bonding or other suitable bonding technique.

“Hydrophilic” describes a material or surface which is wetted by aqueous liquids in contact therewith. The degree of wetting can, in turn, be described in terms of the contact angles and the surface tensions of the liquids and materials involved. Equipment and techniques suitable for measuring the wettability of particular materials or surfaces can be provided by a Cahn SFA-222 Surface Force Analyzer System, or a substantially equivalent system. When measured with this system, materials or surfaces having contact angles less than 90 degrees are designated “wettable” or hydrophilic, and those having contact angles greater than 90 degrees are designated “nonwettable” or hydrophobic.

“Meltblown” refers to fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameters. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al, which is incorporated herein by reference. Meltblown fibers are microfibers which may be continuous or discontinuous, are generally about 0.6 denier or smaller, and are generally self bonding when deposited onto a collecting surface.

“Non-woven” or “non-woven web” refers to materials or webs that are formed without the aid of a textile weaving or knitting process. The composite comprises individual or groups of fibers or threads which are interlaid, but not in an identifiable manner as in a knitted fabric. Non-woven composites have been formed from many processes such as, for example, meltblowing processes, spunbonding processes, and bonded-carded processes.

“Spunbond” refers to small diameter fibers which are formed by extruding molten thermoplastic material as filaments from a plurality of fine capillaries of a spinneret having a circular or other configuration, with the diameter of the extruded filaments then being rapidly reduced by a conventional process such as that described in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Peterson, and U.S. Pat. No. 3,542,615 to Dobo et al., each of which is incorporated herein in its entirety by reference. Spunbond fibers are generally continuous and often have average deniers of about 0.3 or larger, more particularly, between about 0.6 and about 10.

“Superabsorbent” refers to a water-swellable, water-insoluble organic or inorganic material capable, under the most favorable conditions, of absorbing at least about 10 times its weight and, more suitably, at least about 30 times its weight in an aqueous solution containing 0.9 weight percent sodium chloride solution in water.

“Thermoplastic” describes a material that softens when exposed to heat and which substantially returns to a nonsoftened condition when cooled to room temperature.

### BRIEF DESCRIPTION OF THE DRAWINGS

FIG. 1 is a cross-section of apparatus for conducting an Absorbent Composite Permeability Test;

FIG. 2 is a section taken in the plane of line 2-2 of FIG. 1;

FIG. 3 is a cross-section of apparatus for conducting a Liquid Retention Capacity Test;

FIG. 4 is a top plan of apparatus for conducting a Fluid Intake Flowback Evaluation Test;

FIG. 5 is a section taken in the plane of line 5-5 of FIG. 4;

FIG. 6 is Table I in an enlarged format;

FIG. 7 is graph showing composite free swell permeability as a function of surface treatments of composite components;

FIG. 8 is a graph showing composite permeability as a function of void volume;

FIG. 9 is a graph showing fluid intake rates after each of three fluid insults as a function of surface treatments of composite components;

FIG. 10 is a graph showing intake rate as a function of composite pad thickness at the time of insult.

### DETAILED DESCRIPTION

The present invention provides increased void volumes beyond what can be achieved with conventional materials by interacting the materials in a way that results in increased void volume and faster fluid acquisition that is less complex and less expensive than present means known in the art.

Conventional superabsorbent technologies employ passive means for permeability enhancement. No motive forces are utilized in generating the desired flow channels and void volumes to achieve optimal fluid intake rates. However, the present invention focuses on leveraging the repulsive force of “like charges” on the surfaces of individual composite components brought about by particular surface treatments. The present invention makes use of interacting surface charge properties between the components of an absorbent composite when it is insulted with fluid. By selectively treating the surfaces of at least one of the components, such as fluff fiber or SAP, to achieve a desired repulsive force within the composite, high void volumes and increased flow channels can be generated which lead to improved composite fluid intake rates. Thus, the present invention takes advantage of the surface electrical properties (e.g., ionic, surface potential, and cation-anionic interactions) between the individual composite components.

In a dry state, the components of an absorbent composite with either like or opposite electrical surface charges do not interact since there is no liquid interface for the surfaces to exchange electrical charges. Therefore, the high density absorbent composite retains its thin dimensions until fluid is present. However, once a dry composite is wefted by a fluid insult, ionic interactions between the components can occur. The present invention utilizes surface charge treatments to create optimum repulsive (like) charges between the components of an absorbent composite. The repulsive forces promote the expansion of the composite resulting in increased void volume and flow channels, and thus improving composite fluid intake rates.

The present invention is directed generally to absorbent composites having enhanced liquid intake performance characteristics, and more particularly to absorbent composites having enhanced intake rates upon repeated liquid insults thereof or at higher saturation levels. It is understood that absorbent composites produced in accordance with the present invention have a variety of uses. For example, possible uses include incorporation into a disposable or otherwise absorbent article for absorbing various body exudates. Such articles are well known and can include, without limitation, feminine care pads, interlabial products, tampons, diapers, incontinence articles, training pants, bed pads, sweat absorbing pads, shoe pads, bandages, helmet liners, wipes, etc. As another example, the absorbent composite may be useful by itself, such as in the form of a tissue, towel, napkin or the like.

It is contemplated that the material of the present invention can be distributed or otherwise incorporated into an absorbent article employing various techniques. For example, the material of the present invention can be substantially uniformly distributed in the mass of fibers comprising an absorbent body of an absorbent article. The material can also be nonuniformly distributed within an absorbent article, for example, a generally continuous gradient with either an increasing or decreasing concentration of the material of the present invention, as determined by observing the concentration moving from the body-side of an absorbent article to the outer-side of an absorbent article. Alternatively, an absorbent composite or an absorbent article can comprise one or more discrete layers, strips, or sections selectively segregated within the composite or article. For example, the material of the present invention may be segregated within an absorbent composite or an absorbent article to an area where fluid intake flow is higher.

In one example of the invention, the absorbent composite is a SAP/fluff mixture comprising hydrophilic fibers and superabsorbent material. Examples of suitable hydrophilic fibers include naturally occurring organic fibers composed of intrinsically wettable material, such as cellulosic fibers. Suitable sources of cellulosic fibers include: wood fibers, such as bleached kraft softwood or hardwood, high-yield wood fibers, and ChemiThermoMechanical Pulp fibers; bagasse fibers; milkweed fluff fibers; wheat straw; kenaf; hemp; pineapple leaf fibers; or peat moss. Other hydrophilic fibers, such as regenerated cellulose and curled chemically stiffened cellulose fibers may also be densified to form absorbent composites that can expand to a higher loft when wetted. Pulp fibers may also be stiffened by the use of crosslinking agents such as formaldehyde or its derivatives, glutaraldehyde, epichlorohydrin, methylolated compounds such as urea or urea derivatives, dialdehydes such as maleic anhydride, non-methylolated urea derivatives, citric acid or other polycarboxylic acids. Other fibers may include naturally hydrophilic fibers such as polyesters, such as polyethylene terephtalate, and polyamides, such as nylon 6 and nylon 66, or synthetic hydrophobic fibers that have been treated to exhibit hydrophilic properties such as polyolefins, such as polypropylene and polyethylene and copolymers. Other polymers may include polyvinyl chloride, acrylics and acrylic copolymers, polystyrene, polysulfone. Other synthetic fibers may be combinations of one or more of the above polymers in side-by-side and/or sheath-core configuration, commonly referred to as “bi-component” fibers.

Suitable superabsorbent materials include natural, biodegradable, synthetic and modified natural polymers and materials. In addition, the superabsorbent materials can be inorganic materials, such as silica gels, or organic compounds such as cross-linked polymers. The term “cross-linked” used in reference to the superabsorbent material refers to any means for effectively rendering normally water-soluble materials substantially water insoluble but swellable. Such means can include, for example, physical entanglement, crystalline domains, covalent bonds, ionic complexes and associations, hydrophilic associations such as hydrogen bonding, and hydrophobic associations or Van der Waals forces. Examples of synthetic superabsorbent polymers include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof.

The superabsorbent material used in making the absorbent composite is suitably in the form of discrete particles. Superabsorbent particles (SAP) can be of any suitable shape, for example, spiral or semi-spiral, cubic, rod-like, polyhedral, etc. Shapes having a large greatest dimension/smallest dimension ratio, like needles, flakes, and fibers, are also contemplated for use herein. Conglomerates of particles of superabsorbent material may also be used in the absorbent composite. The superabsorbent materials may be in various length and cross-sectional dimensions and may also be in various degrees of neutralization.

The absorbent composite may be formed in any conventional manner, such as by being air-formed, air-laid, bonded-carded or formed by other known techniques in which fibers and superabsorbent material are commingled to form a non-woven web. The absorbent composite may be of substantially any shape and size suitable for its intended purpose. The absorbent composite may also comprise two or more non-woven webs or layers, which may be positioned in side-by-side relationship or surface-to-surface relationship, and all or a portion of adjacent webs or layers may be secured together to form the absorbent composite.

The superabsorbent material is suitably homogeneously mixed with the hydrophilic fibers to provide a uniform distribution of the superabsorbent material and fibers throughout the absorbent composite. Alternatively, the superabsorbent material can be distributed non-uniformly within the absorbent composite, such as across the width, along the length and/or through the thickness of the composite to define discrete target regions or zones of the composite within which the superabsorbent material is located. The concentration of superabsorbent material within the absorbent composite can also be non-uniform through all or part of the thickness, across all or part of the width and/or along all or part of the length of the absorbent composite. In general, the concentration of superabsorbent material within the absorbent composite is suitably about 95 weight percent or less based on the total weight of the absorbent composite, but is in any event greater than zero, for example 5 to 95 percent, particularly 15 to 90 percent, more particularly 25 to 85 percent. In one example, the concentration of superabsorbent material within the absorbent composite is more suitably in the range of about 50 to about 85 weight percent.

The absorbent composite may or may not be wrapped or otherwise encompassed by a suitable tissue wrap for maintaining the integrity and/or shape of the absorbent composite.

The absorbent composite also has certain liquid intake performance characteristics, including absorbent composite permeability, retention capacity, void volume and intake rate, which are measurable using the tests described below.

Absorbent Composite Permeability Test

The following test is used to determine the permeability of the absorbent composite, and more particularly a “z-direction” permeability of the absorbent composite based on liquid flow through the thickness of the composite. The test is conducted at under what is commonly referred to as “free swell” conditions. The term “free swell” means that the superabsorbent material in the absorbent composite is allowed to swell without a swell restraining load applied thereto upon absorbing test solution.

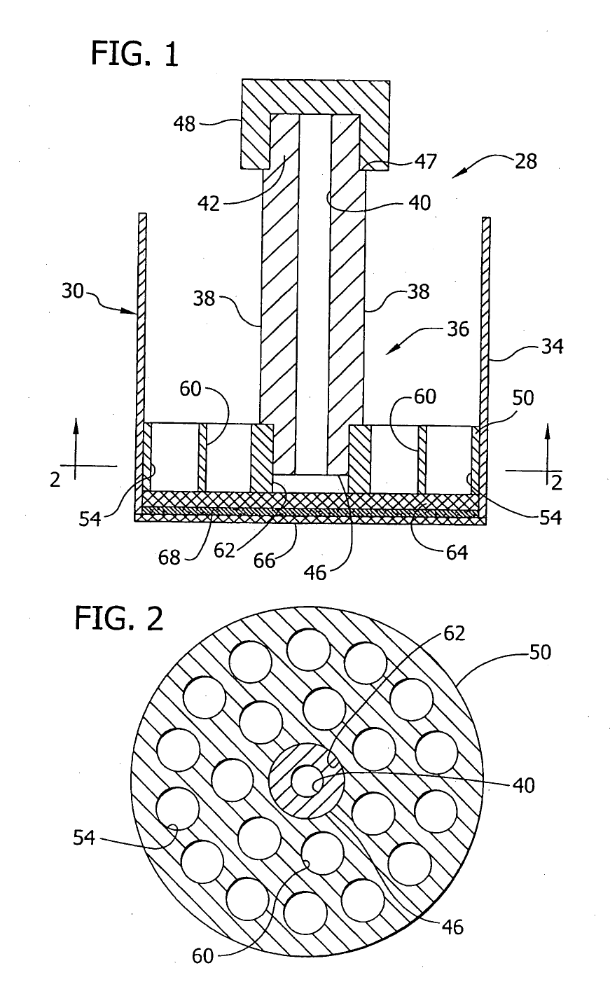

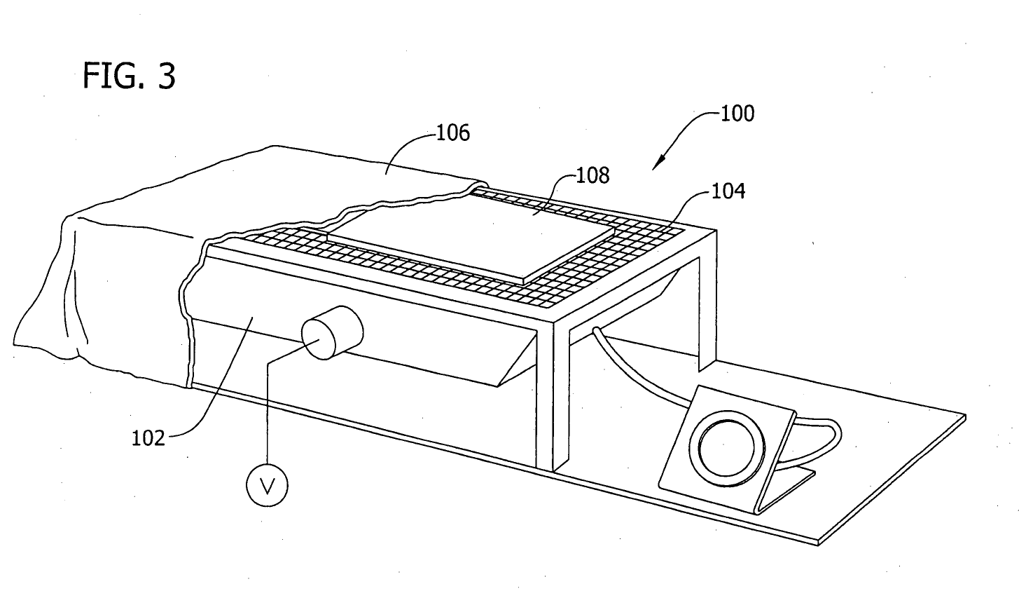

A suitable Permeability Test apparatus is shown in FIGS. 1 and 2 and indicated generally in FIG. 1 as 28. The test apparatus comprises a sample container, generally indicated at 30, and a piston, generally indicated at 36. The piston 36 comprises a cylindrical LEXAN shaft 38 having a concentric cylindrical hole 40 bored down the longitudinal axis of the shaft. Both ends of the shaft 38 are machined to provide upper and lower ends respectively designated 42, 46. A weight, indicated as 48, rests on one end 42. A circular piston head 50 is positioned on the other end 46 and is provided with a concentric inner ring of seven holes 60, each having a diameter of about 0.95 cm, and a concentric outer ring of fourteen holes 54, also each having a diameter of about 0.95 cm. The holes 54, 60 are bored from the top to the bottom of the piston head 50. The piston head 50 also has a cylindrical hole 62 bored in the center thereof to receive end 46 of the shaft 38. The bottom of the piston head 50 may also be covered with a biaxially stretched 400 mesh stainless steel screen 64. A suitable screen 64 material is part number 85385T972 from McMaster-Carr Supply of Chicago, Ill., U.S.A.

The sample container 30 comprises a cylinder 34 and a 100 mesh stainless steel cloth screen 66 that is biaxially stretched to tautness and attached to the lower end of the cylinder prior to attachment. A suitable material for the screen 66 is part number 85385T976 from McMaster-Carr Supply, a company having offices in Chicago, Ill., U.S.A. An absorbent composite sample, indicated as 68 in FIG. 1, is supported on the screen 66 within the cylinder 34 during testing.

The cylinder 34 may be bored from a transparent LEXAN rod or equivalent material, or it may be cut from a LEXAN tubing or equivalent material, and has an inner diameter of about 6 cm and a height of approximately 10 cm. The cylinder 34 includes a set of drainage holes (not shown) or other suitable means for holding a fluid level in the sample container at approximately 7.8 cm above the screen 66. The piston head 50 is machined from a LEXAN rod or equivalent material and has a height of approximately 16 mm and a diameter sized such that it fits within the cylinder 34 with minimum wall clearance but still slides freely. The shaft 38 is machined from a LEXAN rod or equivalent material and has an outer diameter of about 2.32 cm and an inner diameter of about 0.64 cm.

The shaft upper end 42 is approximately 2.54 cm long and approximately 1.52 cm in diameter, forming an annular shoulder 47 to support the weight 48. The annular weight 48 has an inner diameter of about 1.59 cm so that it slips onto the upper end 42 of the shaft 38 and rests on the annular shoulder 47 formed thereon. The annular weight 48 can be made from stainless steel or from other suitable materials resistant to corrosion in the presence of 0.9 weight percent saline solution. The combined weight of the piston 36 and annular weight 48 equals approximately 596 grams (g), which corresponds to a pressure applied to the absorbent composite sample 68 of about 0.3 pounds per square inch (psi), or about 20.7 dynes/cm2, over a sample area of about 28.27 cm2.

When test solution flows through the test apparatus 28 during testing as described below, the sample container 30 generally rests on a 16 mesh rigid stainless steel support screen (not shown). Alternatively, the sample container 30 may rest on a support ring (not shown) diametrically sized substantially the same as the cylinder 34 so that the support ring does not restrict flow from the bottom of the sample container.

To conduct the Absorbent Composite Permeability Test, the piston 36, with the weight 48 seated thereon, is placed in an empty sample container 30 and the height from the bottom of the weight to the top of the cylinder 34 is measured using a caliper or suitable gauge accurate to 0.01 mm. It is important to measure the height of each sample container 30 empty and to keep track of which piston 36 and weight 48 is used when using multiple test apparatus 28. The same piston 36 and weight 48 should be used for measurement when the absorbent composite sample 68 is later swollen following saturation.

A circular absorbent composite sample 68 (e.g., either formed or otherwise cut from a larger absorbent composite), with the tissue wrap removed and having a cross-sectional diameter of about 6 cm is placed in the sample container 30 at the bottom of the cylinder 34 in contact with the screen 64. The sample container 30 is submerged in a test solution comprising 0.9 weight percent saline solution for a time period of about 60 minutes to saturate the absorbent composite sample 68. Without the piston 36 and weight 48 assembly on the sample during saturation, the superabsorbent material within the absorbent composite sample 68 is allowed to swell without a restraining load being applied thereto (e.g., under free swell conditions). After 60 minutes, the piston 36 and weight 48 assembly is placed on the saturated absorbent composite sample 68 in the absorbent composite sample container 30 and then the absorbent composite sample container 30, piston 36, weight 48, and absorbent composite sample 68 are removed from the test solution. The thickness of the saturated absorbent composite sample 68 is determined by again measuring the height from the bottom of the weight 48 to the top of the cylinder 34, using the same caliper or gauge used previously provided that the zero point is unchanged from the initial height measurement. The height measurement obtained from measuring the empty absorbent composite sample container 30, piston 36, and weight 48 is subtracted from the height measurement obtained after saturating the absorbent composite sample 68. The resulting value is the thickness, or height “H” of the saturated absorbent composite sample 68.

The absorbent composite permeability measurement is initiated by delivering a flow of test solution into the sample container 30 with the saturated absorbent composite sample 68, piston 36, and weight 48 inside. The flow rate of test solution into the container 30 is adjusted to maintain a fluid height of about 7.8 cm above the bottom of the sample container. The quantity of test solution passing through the absorbent composite sample 68 versus time is measured gravimetrically. Data points are collected every second for at least twenty seconds once the fluid level has been stabilized to and maintained at about 7.8 cm in height. The flow rate Q through the swollen absorbent composite sample 68 is determined in units of grams/second (g/s) by a linear least-square fit of fluid passing through the absorbent composite sample 68 (in grams) versus time (in seconds).

Permeability in square microns is obtained by the following equation:
K=[Q*H*Mu*108]/[A*Rho*P]
where K=Permeability (cm2), Q=flow rate (g/sec), H=height of sample (cm), Mu=liquid viscosity (poise) (approximately one centipoise for the test solution used with this Test), A=cross-sectional area for liquid flow (cm2), Rho=liquid density (g/cm3) (approximately one g/cm3, for the test solution used with this Test) and P=hydrostatic pressure (dynes/cm2) (normally approximately 3,923 dynes/cm2). The hydrostatic pressure is calculated from
P=Rho*g*h
where Rho=liquid density (g/cm3), g=gravitational acceleration, nominally 981 cm/sec2, and h=fluid height, e.g., 7.8 cm for the Absorbent Composite Permeability Test described herein.

Four samples of an absorbent composite are tested and the results are averaged to determine the absorbent composite permeability.

Liquid Saturation Retention Capacity Test

The following test is used to determine a retention capacity of an absorbent composite, i.e., the capacity of the absorbent composite for retaining liquid therein. Referring to FIG. 3, an absorbent composite sample 108 having a diameter of about three (3) inches (approximately 7.62 cm) is weighed with the tissue wrap material on and the weight in grams is recorded. The absorbent composite sample 108 is then wrapped in toweling (not shown), such as Scott Hi-Dri available from Kimberly-Clark of Neenah, Wis., U.S.A., and submerged in an excess quantity of test solution (i.e., 0.9 weight percent saline solution at about 23 degrees Celsius) for twenty minutes. After this time period, the towel wrapped absorbent composite sample 108 is removed from the test solution and placed on a retention capacity test apparatus, indicated generally at 100 in FIG. 3, comprising a vacuum box 102, a TEFLON fiberglass screen 104 having 0.25 inch (0.6 cm) openings and supported by the vacuum box, and a flexible rubber cover 106 sized for overlaying the screen on the vacuum box.

More particularly, the absorbent composite sample 108 (with toweling) is placed uncovered (e.g., by the rubber cover 106) on the screen 104 and allowed to drip dry for about one minute. The rubber cover 106 is then placed over the absorbent composite sample 108 and screen 104 (e.g., to generally form a seal over the vacuum box 102) and a vacuum (V) of about 0.5 pounds/square inch (about 34.5 dynes/square cm) is drawn on the vacuum box (and thus the absorbent composite sample) for a period of about five minutes. The absorbent composite sample 108 is then removed from the toweling, making an effort to recover loose fibers and superabsorbent particles along with the absorbent composite sample. The recovered sample is again weighed and the weight in grams is recorded. A “total retention capacity” of the absorbent composite sample 108 is determined by subtracting the dry weight of the absorbent composite sample from the weight of the recovered absorbent composite sample after application of the vacuum and is recorded as grams of liquid retained. For relative comparisons to absorbent composites of different mass, a “normalized retention capacity” is determined as the total retention capacity divided by the dry weight of the absorbent composite sample 108 and is recorded as grams of liquid retained per gram of absorbent composite (g/g, or gliq./gabs.).

If fibers and/or superabsorbent material of the absorbent composite sample 108 are drawn through the fiberglass screen into the vacuum box 102 during testing, a screen having smaller openings should be used and the test should be re-done. Alternatively, a piece of tea bag material or other similar material can be placed between the absorbent composite sample 108 and the screen and the total retention capacity adjusted for the liquid retained by the tea bag or other material.

Centrifuge Retention Capacity Test

The Centrifuge Retention Capacity (CRC) Test measures the ability of the gel particles (e.g., such as the surface treated absorbent material or the superabsorbent material prior to being surface treated) to retain liquid therein after being saturated and subjected to centrifugation under controlled conditions. The resultant retention capacity is stated as grams of liquid retained per gram weight of the sample (g/g). The sample to be tested is prepared from particles which are prescreened through a U.S. standard 30 mesh screen and retained on a U.S. standard 50 mesh screen. As a result, the sample comprises particles sized in the range of about 300 to about 600 microns. The particles can be prescreened by hand or automatically and are stored in a sealed airtight container until testing.

The retention capacity is measured by placing 0.2±0.005 grams of the prescreened sample into a water-permeable bag which will contain the sample while allowing a test solution (0.9 weight percent sodium chloride in distilled water) to be freely absorbed by the sample. A heat-sealable tea bag material, such as that available from Dexter Corporation of Windsor Locks, Conn., U.S.A., as model designation 1234T heat sealable filter paper works well for most applications. The bag is formed by folding a 5-inch by 3-inch sample of the bag material in half and heat-sealing two of the open edges to form a 2.5-inch by 3-inch rectangular pouch. The heat seals should be about 0.25 inches inside the edge of the material. After the sample is placed in the pouch, the remaining open edge of the pouch is also heat-sealed. Empty bags are also made to serve as controls. Three samples (e.g., filled and sealed bags) are prepared for the test. The filled bags must be tested within three minutes of preparation unless immediately placed in a sealed container, in which case the filled bags must be tested within thirty minutes of preparation.

The bags are placed between two TEFLON® coated fiberglass screens having 3 inch openings (Taconic Plastics, Inc., Petersburg, N.Y.) and submerged in a pan of the test solution at 23 degrees Celsius, making sure that the screens are held down until the bags are completely wetted. After wetting, the samples remain in the solution for about 30±1 minutes, at which time they are removed from the solution and temporarily laid on a non-absorbent flat surface. For multiple tests, the pan should be emptied and refilled with fresh test solution after 24 bags have been saturated in the pan.

The wet bags are then placed into the basket of a suitable centrifuge capable of subjecting the samples to a g-force of about 350. One suitable centrifuge is a Heraeus LaboFuge 400 having a water collection basket, a digital rpm gauge, and a machined drainage basket adapted to hold and drain the bag samples. Where multiple samples are centrifuged, the samples must be placed in opposing positions within the centrifuge to balance the basket when spinning. The bags (including the wet, empty bags) are centrifuged at about 1,600 rpm (e.g., to achieve a target g-force of about 350), for 3 minutes. The bags are removed and weighed, with the empty bags (controls) being weighed first, followed by the bags containing the samples. The amount of solution retained by the sample, taking into account the solution retained by the bag itself, is the centrifuge retention capacity (CRC) of the sample, expressed as grams of fluid per gram of sample. More particularly, the retention capacity is determined as:

$$CRC = \frac{\begin{matrix}sample \text{/} bag weight after centrifuge - empty bag weight \\ after centrifuge \text{-} dry sample weight\end{matrix}}{dry sample weight}$$

The three samples are tested and the results are averaged to determine the centrifuge retention capacity (CRC). The samples are tested at 23±1 degrees Celsius at 50±2 percent relative humidity.

Fluid Intake Evaluation Test

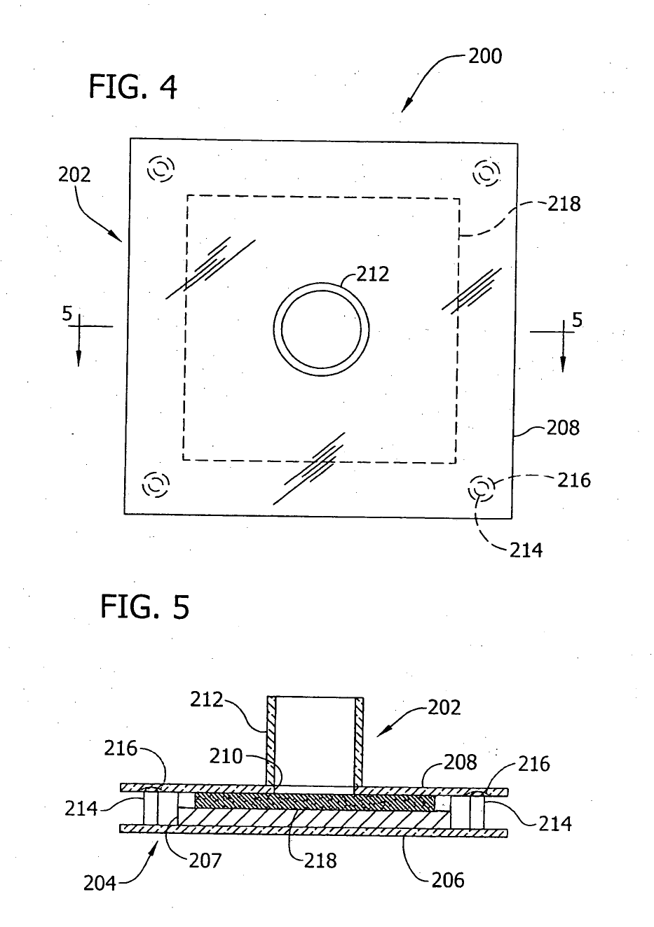

The Fluid Intake Evaluation (FIE) Test determines the amount of time required for an absorbent composite, and more particularly a sample thereof, to acquire (but not necessarily absorb) a known amount of test solution (0.9 weight percent saline solution). A suitable apparatus for performing the FIE Test is shown in FIGS. 4 and 5 and is generally indicated at 200. The test apparatus 200 comprises upper and lower assemblies, generally indicated at 202 and 204 respectively. The lower assembly 204 comprises a generally 7 inch by 7 inch (45 cm by 45 cm) square plate 206 constructed of a transparent material such as plexiglass and a generally 4.5 inch (11.4 cm) by 4.5 inch (11.4 cm) square platform 207 centered on the plate for centering the absorbent composite sample during the test.

The upper assembly 202 comprises a generally square plate 208 constructed similar to the lower plate 206 and having a central opening 210 formed therein. A cylinder 212 having an inner diameter of about one inch is secured to the upper plate 208 at the central opening 210 and extends upward substantially perpendicular to the upper plate. The central opening 210 of the upper plate 208 should have a diameter at least equal to the inner diameter of the cylinder 212 where the cylinder is mounted on top of the upper plate. However, the diameter of the central opening 210 may instead be sized large enough to receive the outer diameter of the cylinder 212 within the opening so that the cylinder is secured to the upper plate 208 within the central opening.

Pin elements 215 are located near outside corners of the lower plate 206, and corresponding recesses 216 in the upper plate 208 are sized to receive the pin elements to properly align and position the upper assembly 202 on the lower plate during testing. The weight of the upper assembly 202 (e.g., the upper plate 208 and cylinder 212) is suitable for simulating approximately 0.11 pounds/square inch (psi), or about 7.59 dynes/square cm, pressure on the absorbent composite sample during the FIE Test.

To run the FIE Test, an absorbent composite sample 218 having a diameter of about three (3) inches (about 7.62 cm) is weighed, with the tissue wrap on, and the weight is recorded in grams. The upper assembly 202 is placed over the lower assembly 204 in opposed relationship with the lower assembly 204 without a sample, with the pin elements 215 of the lower plate seated in the recesses 216 formed in the upper plate 208 and with the cylinder 212 generally centered over the lower plate 206, the height is measured using a caliper or suitable gauge accurate to 0.1 mm. The absorbent composite sample 218 is then centered on the lower plate 206 of the test apparatus 200 and the upper assembly 202 is again placed over the absorbent composite sample in opposed relationship with the lower plate 206, with the pin elements 215 of the lower plate seated in the recesses 216 formed in the upper plate 208 and the cylinder 212 generally centered over the absorbent composite sample. The absorbent composite sample thickness is measured under a pressure of 0.11 psi using a caliper or suitable gauge accurate to 0.1 mm and recorded. A test solution (0.9 weight percent saline solution) is prepared with a small amount of blue dye added thereto. A first predetermined amount of the test solution (e.g., to simulate a first insult of the absorbent composite), corresponding to approximately 30 percent of the total Liquid Saturation Retention Capacity of the absorbent composite as determined by the Centrifuge Retention Capacity Test set forth above, is poured into a beaker. The test solution is then poured into the top of the cylinder 212 and allowed to flow down into the absorbent composite sample 218. A stopwatch is started when the first drop of solution contacts the absorbent composite sample 218 and is stopped when the liquid ring between the edge of the cylinder 212 and the absorbent composite sample disappears. The reading on the stopwatch is recorded to two decimal places and represents the intake time (in seconds) required for the first insult to be taken into the absorbent composite sample 218.

A time period of fifteen minutes is allowed to elapse, after which the thickness of the absorbent composite sample 218 5is measured as described above and a second insult equal to the first insult (e.g., to simulate a second insult of the absorbent composite to cumulatively achieve approximately 60 percent of the total Liquid Saturation Retention Capacity of the absorbent composite) is poured into the top of the cylinder 212 and again the intake time is measured as described above. After an additional fifteen minutes, the absorbent composite sample 218 is again measured for thickness as described above and the insult procedure is repeated for a third insult, also equal to the first insult, e.g., to simulate a third insult of the absorbent composite to cumulatively achieve approximately 90 percent of the total Liquid Saturation Retention Capacity of the absorbent composite. The thickness of the sample in each case is the difference between the upper assembly height 202 measured with the dry sample 218 or measured after each insult, and the height of the upper assembly 202 without any sample.

An intake rate (e.g., in milliliters/second) for each of the three insults is determined by dividing the amount of liquid for each insult by the intake time measured for the corresponding insult.

While the FIE Test as described above is typically conducted with the tissue wrap on the absorbent composite sample, in instances where the intake rate is expected to exceed about 6 ml/sec, the tissue wrap of the portion of the sample which faces the upper plate of the test apparatus should be removed and replaced with a flexible plastic screen having a mesh size of about 18 openings per inch to avoid impeding the flow of solution into the sample.

At least three samples of each absorbent composite are subjected to the FIE Test and the results are averaged to determine the intake time and intake rate of the absorbent composite.

Void Volume Calculation

A relative measure of open volume of a swelled composite of the present invention can be calculated from the swelled thickness obtained from the Absorbent Composite Permeability Test (described above) and the values obtained from the Centrifuge Retention Capacity Test (described above) for superabsorbent and fiber fractions, as well as the initial dry density of the components. The resultant calculation results in a value referred to as “Void Volume,” which is the open volume measured in cubic centimeters per gram (cm³/g) of absorbent composite under a 0.3 psi load in accordance to the Absorbent Composite Permeability Test. The Void Volume calculated value indicates the amount of open volume between the swelled composite components on a per gram basis of dry absorbent weight. This calculation normalizes the void volume generated between the examples and allows for simple comparison between them, with higher numbers indicating more void volume with the swelled samples.

The Void Volume in cubic centimeters per gram is obtained by the following equation:
W=OV/mₛₐₘₚₗₑ

where W=Void Volume (cm³/g), OV=Open Volume (cm³), and mₛₐₘₚₗₑ=the weight of the sample (g). The open volume is calculated from:
OV=SV−UV

where SV=Total Swelled Volume (cm³) and UV=volume unavailable for fluid flow (cm³). The Total Swelled Volume is obtained from the Absorbent Composite Permeability Test and is calculated from:
SV=H×A

where H=wet thickness height of the sample (cm) and A=cross-sectional area for liquid flow (cm²). The volume unavailable for fluid flow is calculated from:
UV=([mₛₐₘₚₗₑ/Rho_{d}]+[mₛₐₚ×CRCₛₐₚ]+[m_{fiber}×CRC_{fiber}])

where mₛₐₘₚₗₑ=total dry weight of the sample (g), Rho_{d}=density of the dry components (g/cm³) (both the SAP and fluff components were estimated at 1.5 g/cm³), mₛₐₚ=weight of the superabsorbent particle fraction (g), CRCₛₐₚ=the CRC value for the superabsorbent particle fraction (grams liquid/grams SAP), m_{fiber}=weight of the fiber fraction (g), and CRC_{fiber}=the CRC value for the fiber fraction (grams liquid/grams fiber).

Experiment

Absorbent composite samples having different absorbent composite permeabilities and retention capacities were made in a laboratory air-forming apparatus and subjected to the Absorbent Composite Permeability Test, Retention Capacity Test and FIE Test to evaluate the relationship between the absorbent composite permeability, retention capacity and intake rate of absorbent composites upon repeated insults thereof. An effort was made to maintain similar dry densities and basis weights between samples as not to bias the experiment. Each of the absorbent composite samples comprised one of three different hydrophilic fibers. Fiber I, SUPERSOFT N made by International Paper of Georgetown, S.C., U.S.A. has a fiber CRC of 1.13 g/g, and was used as a control fiber representing commodity fluff pulp. Fiber II, EXCELLULOSE made by National Starch of Bridgewater, New Jersey, U.S.A. has a fiber CRC of 0.78 g/g and is a cellulosic fiber chemically modified to form aldehyde and carbonyl surface functionality. Fiber III comprises SUPERSOFT N chemically treated in the lab with 0.1 percent Chitosan made by Sigma-Aldrich of St. Louis, Mo., U.S.A. and has a fiber CRC of 0.87 g/g. An example procedure for treating the SUPERSOFT N fiber with Chitosan is as follows:
Measure out two (2) grams of Chitosan, catalog number 44886-9, CAS number 9012-76-4 from Signma Aldrich of St. Louis, Mo., U.S.A. Then weigh out 124 g of 0.1N HCl. Dissolve the Chitosan slowly in the 0.1N HCl. Distilled water may be added to allow for more volume. Complete the volume to 1000 milliliters, measured in grams. All materials should be weighed out. The Chitosan takes approximately 30-60 minutes to dissolve. Some pieces of chitosan will not totally dissolve. The pH should be about 2.5. Just before adding to fiber, the pH should be increased to approximately 4.0. Four (4) grams of NaOH can be dissolved in one (1) liter of distilled water to make a 0.1N solution, which can then be used to increase the pH (about 35 milliliters are required). Eight (8) grams of fiber are then soaked in 1000 grams of distilled water for about one (1) minute. The Chitosan solution is then added to the fiber, resulting in a total volume of 2000 milliters (2000 grams) and thus obtaining a 0.1 percent Chitosan solution. The reaction time is about thirty (30) seconds. The slurry is then poured into a wet-laid handsheet mold, mixed using a stir plate, and drained. Two (2) blotters are used to remove it from the wire. The handsheet is then removed from the blotters and placed on aluminum foil. The handsheets are air dried overnight. The handsheets are then fiberized using a laboratory fiberizer.
   It should be understood that alternative methods for treating fiber could be used without departing from the scope of the invention.

Each of the absorbent composite samples also comprised one of two different types of superabsorbent particles (SAP). Type I, FAVOR SXM-9543, is made by Stockhausen, Inc. of Greensboro, N.C., U.S.A. and has a SAP CRC of 23 g/g. Type II is FAVOR SXM-9543 treated with 0.2 percent by weight CATIOFAST PR-8106 (made by BASF of Ludvigshafen am Rhein, Germany) and has a SAP CRC of 22.1 g/g. An example procedure for treating the FAVOR SXM-9543 with CATIOFAST PR-8106 is as follows:
A twenty-five (25) percent by weight CATIOFAST PR-8106 aqueous solution was diluted with deionized water to 12.5 percent solids. Eighty-eight (88) grams of the diluted solution was introduced via spray unit in a fluidized bed reactor to 500 grams FAVOR SXM-9543. The coating process was allowed to occur at room temperature until all the liquid was either absorbed into the superabsorbent particle or evaporated (approximately thirty (30) seconds). This process resulted in an unsubstantially swelled SAP particle with a coating of approximately two (2) percent solid polyvinaylamine polymer on the particle surfaces. The coated SAP particles remain relatively unmodified in shape and size compared to the original FAVOR SXM-9543.
The fluidized bed coating process used is described in U.S. Pat. Nos. 3,117,027, 3,196,827, 3,241,520, and 3,253,944. Essentially, a fluidized bed has been modified so that air enters the bed non-uniformly. While the entire chamber is fluidized, air comes in most strongly at the center of the chamber and forms a fountain, which is allowed to rise into an expansion chamber. When the bed is loaded with particulates, the particulates rise with the air fountain, then cascade down the outside of the apparatus when the fountain becomes too attenuated to support them. When the particles reach the bottom, they are again drawn into the air fountain, setting up a regular circulation of the particulates within the apparatus. A spray unit is positioned at the base of the air fountain and the coating material is sprayed as a fine mist onto the particulates as they move past. In this way, coatings can be applied to particulates with exceptional uniformity. The fluidized bed used is a single nozzle design with a variable bed diameter (2 to 9 inches) and a variable volume (500 to 2000 milliliters).
   It should be understood that alternative methods for treating superabsorbent particles could be used without departing from the scope of the invention.

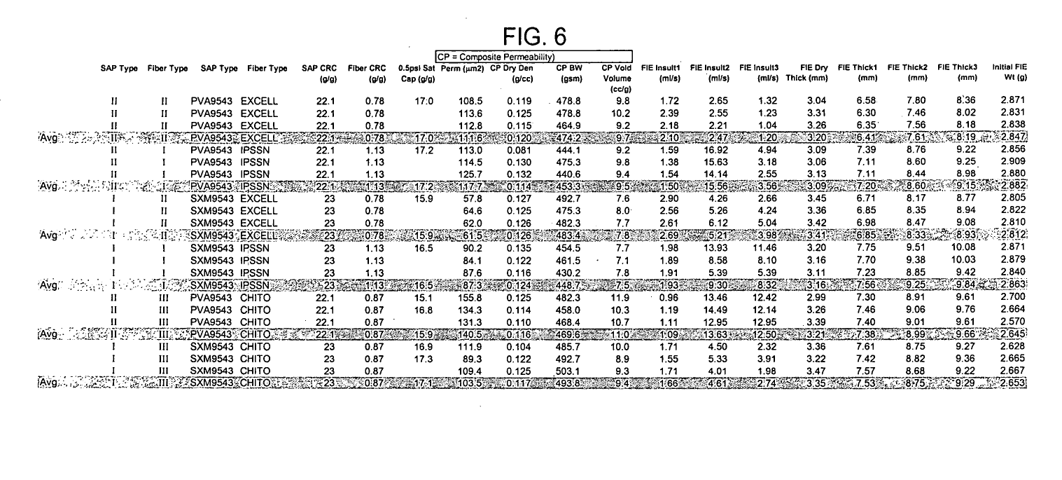

Six different combination of the fibers and superabsorbent materials were used to form absorbent composites (using a laboratory air-forming device) as set forth in Table 1 below. For each absorbent composite, ten different samples were formed for testing. A three (3) inch diameter handsheet former was used to prepare the absorbent composites, with a target of fifty-five (55) percent by weight fiber and forty-five (45) percent by weight superabsorbent. Pads were made to have homogeneous mixing of SAP and fluff at a 600 gsm total basis weight and densified to 0.12 g/cc using a CARVER press. The fluid intake rates and void volumes were determined using the tests and calculations described above and recorded in Table I below, and can also be seen as FIG. 6.

TABLE 1
CP = Composite Permeability

| | | | | | SAP CRC | Fiber CRC | 0.5 pml 9 wt | | CP Dry Den | CP BW |
|---|---|---|---|---|---|---|---|---|---|---|
| | SAP Type | Fiber Type | SAP Type | Fiber Type | (g/g) | (g/g) | Cap (g/g) | Parm (μm2) | (g/cc) | (gsm) |
| | II | II | PVA9543 | EXCELL | 22.1 | 0.78 | 17.0 | 108.5 | 0.119 | 478.8 |
| | II | II | PVA9543 | EXCELL | 22.1 | 0.78 | | 113.6 | 0.125 | 478.8 |
| | II | II | PVA9543 | EXCELL | 22.1 | 0.78 | | 112.8 | 0.115 | 464.9 |
| Avg | II | II | PVA9543 | EXCELL | 22.1 | 0.78 | 17.0 | 111.6 | 0.120 | 474.2 |
| | II | I | PVA9543 | IPSSN | 22.1 | 1.13 | 17.2 | 113.0 | 0.081 | 444.1 |
| | II | I | PVA9543 | IPSSN | 22.1 | 1.13 | | 114.5 | 0.130 | 475.3 |
| | II | I | PVA9543 | IPSSN | 22.1 | 1.03 | | 125.7 | 0.132 | 440.6 |
| Avg | II | I | PVA9543 | IPSSN | 22.1 | 1.13 | 17.2 | 117.7 | 0.114 | 453.3 |
| | I | II | SXM9543 | EXCELL | 23 | 0.78 | 15.9 | 57.8 | 0.127 | 492.7 |
| | I | II | SXM9543 | EXCELL | 23 | 0.78 | | 64.6 | 0.125 | 475.3 |
| | I | II | SXM9543 | EXCELL | 23 | 0.78 | | 62.0 | 0.126 | 482.3 |
| Avg | I | II | SXM9543 | EXCELL | 23 | 0.78 | 15.9 | 61.5 | 0.126 | 483.4 |
| | I | I | SXM9543 | IPSSN | 23 | 1.13 | 16.5 | 90.2 | 0.135 | 454.5 |
| | I | I | SXM9543 | IPSSN | 23 | 1.13 | | 84.1 | 0.122 | 461.5 |
| | I | I | SXM9543 | IPSSN | 23 | 1.13 | | 87.6 | 0.116 | 430.2 |
| Avg | I | I | SXM9543 | IPSSN | 23 | 1.13 | 16.5 | 67.3 | 0.124 | 448.7 |
| | II | III | PVA9543 | CHITO | 22.1 | 0.87 | 15.1 | 155.8 | 0.125 | 482.3 |
| | II | III | PVA9543 | CHITO | 22.1 | 0.87 | 16.8 | 134.3 | 0.114 | 458.0 |
| | II | III | PVA9543 | CHITO | 22.1 | 0.87 | | 131.3 | 0.110 | 468.4 |
| Avg | II | III | PVA9543 | CHITO | 22.1 | 0.87 | 15.9 | 140.5 | 0.116 | 469.6 |
| | I | III | SXM9543 | CHITO | 23 | 0.87 | 16.9 | 111.9 | 0.104 | 485.7 |
| | I | III | SXM9543 | CHITO | 23 | 0.87 | 17.3 | 89.3 | 0.122 | 492.7 |
| | I | III | SXM9543 | CHITO | 23 | 0.87 | | 109.4 | 0.125 | 503.1 |
| Avg | I | III | SXM9543 | CHITO | 23 | 0.87 | 17.1 | 103.5 | 0.117 | 493.6 |

| | | CP Void | | | | | | | FIE | Initial |
|---|---|---|---|---|---|---|---|---|---|---|
| | | Volume | FIE Insult1 | FIE Insult2 | FIE Insult3 | FIE Dry | FIE Thick1 | FIE Thick2 | Thick3 | FIE |
| | SAP Type | (cc/g) | (ml/s) | (ml/s) | (ml/s) | Thick (mm) | (mm) | (mm) | (mm) | Wt (g) |
| | II | 9.8 | 1.72 | 2.65 | 1.32 | 3.04 | 6.58 | 7.80 | 8.36 | 2.871 |
| | II | 10.2 | 2.39 | 2.55 | 1.23 | 3.31 | 6.30 | 7.46 | 8.02 | 2.831 |
| | II | 9.2 | 2.18 | 2.21 | 1.04 | 3.26 | 6.35 | 7.56 | 8.18 | 2.838 |
| Avg | II | 9.7 | 2.10 | 2.47 | 1.20 | 3.20 | 6.41 | 7.61 | 8.19 | 2.847 |
| | II | 9.2 | 1.59 | 16.92 | 4.94 | 3.09 | 7.39 | 8.76 | 9.22 | 2.856 |
| | II | 9.6 | 1.38 | 15.63 | 3.18 | 3.06 | 7.11 | 8.60 | 9.25 | 2.909 |
| | II | 9.4 | 1.54 | 14.14 | 2.55 | 3.13 | 7.11 | 8.44 | 8.98 | 2.880 |
| Avg | II | 9.5 | 1.60 | 15.58 | 3.56 | 3.09 | 7.20 | 8.60 | 9.15 | 2.882 |
| | I | 7.6 | 2.90 | 4.26 | 2.66 | 3.45 | 6.71 | 8.17 | 8.77 | 2.805 |
| | I | 6.0 | 2.56 | 5.26 | 4.24 | 3.36 | 6.85 | 8.35 | 8.94 | 2.822 |
| | I | 7.7 | 2.61 | 6.12 | 5.04 | 3.42 | 6.98 | 8.47 | 9.08 | 2.810 |
| Avg | I | 7.8 | 2.69 | 5.21 | 3.98 | 3.41 | 6.85 | 8.33 | 8.93 | 2.812 |
| | I | 7.7 | 1.98 | 13.93 | 11.46 | 3.20 | 7.75 | 9.51 | 10.08 | 2.871 |
| | I | 7.1 | 1.89 | 8.58 | 8.10 | 3.16 | 7.70 | 9.38 | 10.03 | 2.879 |
| | I | 7.8 | 1.91 | 5.39 | 5.39 | 3.11 | 7.23 | 8.85 | 9.42 | 2.840 |
| Avg | I | 7.5 | 1.93 | 9.30 | 8.32 | 3.16 | 7.56 | 9.25 | 9.64 | 2.883 |
| | II | 11.9 | 0.96 | 13.46 | 12.42 | 2.99 | 7.30 | 8.91 | 9.61 | 2.700 |
| | II | 10.3 | 1.19 | 14.49 | 12.14 | 3.26 | 7.46 | 9.06 | 9.76 | 2.664 |
| | II | 10.7 | 1.11 | 12.95 | 12.95 | 3.39 | 7.40 | 9.01 | 9.61 | 2.570 |
| Avg | II | 11.0 | 1.09 | 13.63 | 12.50 | 3.21 | 7.38 | 8.99 | 9.66 | 2.645 |
| | I | 10.0 | 1.71 | 4.50 | 2.32 | 3.36 | 7.61 | 8.75 | 9.27 | 2.628 |
| | I | 8.9 | 1.55 | 5.33 | 3.91 | 3.22 | 7.42 | 8.62 | 9.36 | 2.665 |
| | I | 9.3 | 1.71 | 4.01 | 1.98 | 3.47 | 7.57 | 8.68 | 9.22 | 2.667 |
| Avg | I | 9.4 | 1.66 | 4.61 | 2.74 | 3.35 | 7.53 | 8.75 | 9.29 | 2.653 |

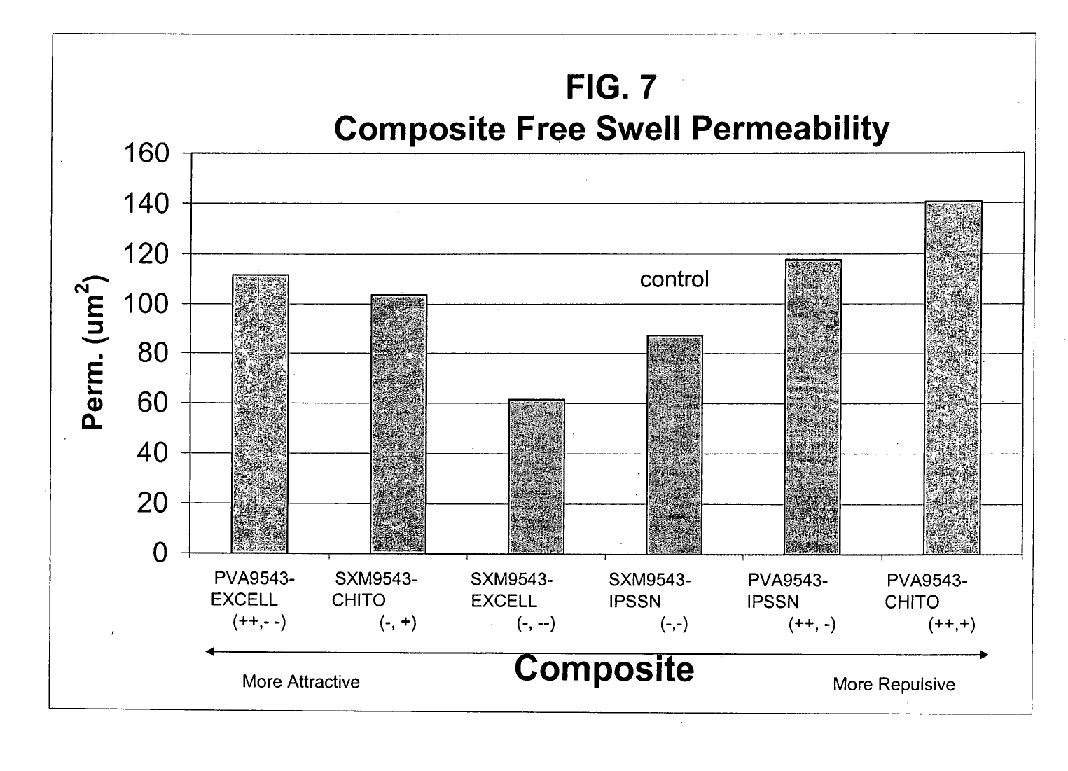

FIG. 7 demonstrates the composite free swell permeability for the treated and untreated component combinations of Table 1. It can be seen that the repulsive forces produced from the CATIOFAST coated SAP/Chitosan treated fluff combination resulted in the highest degree of composite free swell permeability and void volume. This increase in composite free swell permeability corresponds to desirable improved fluid intake rates at high saturation levels of composite, which is necessary to prevent premature leakage.

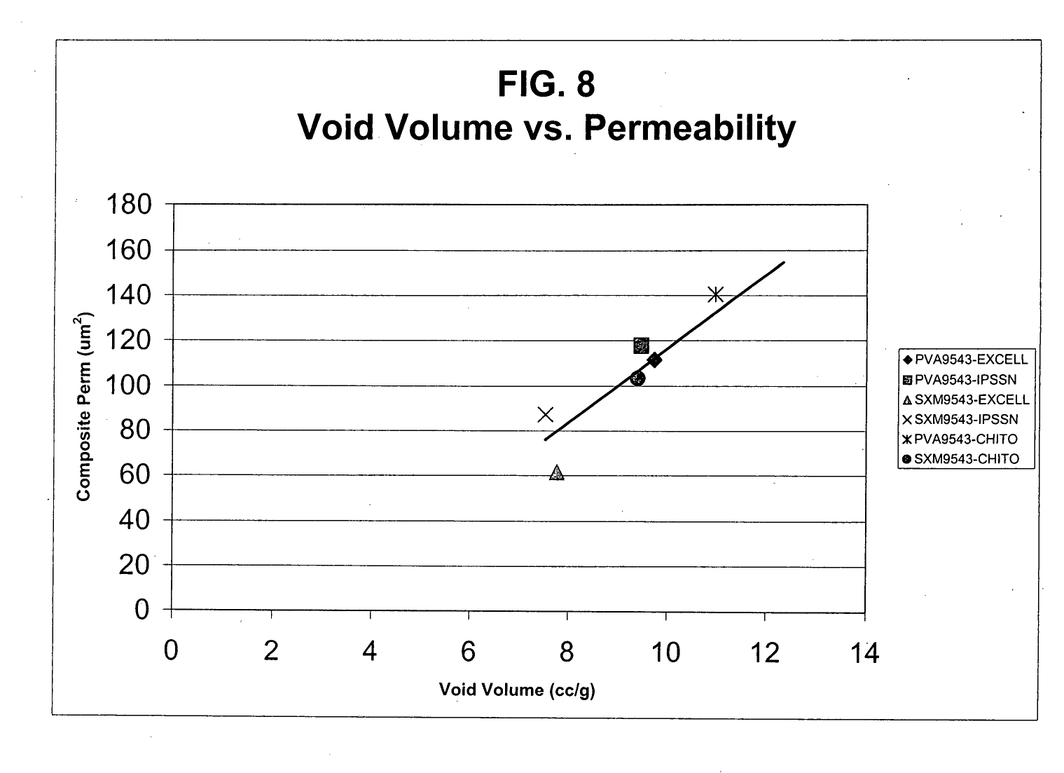

FIG. 8 demonstrates that a linear relationship exists between void volume and permeability, thus establishing that void volume is a significant driver of composite permeability response. Modification of composite component surface charges to produce a desired repulsive force results in an increase of both void volume and permeability, which in turn results in improved fluid intake rates.

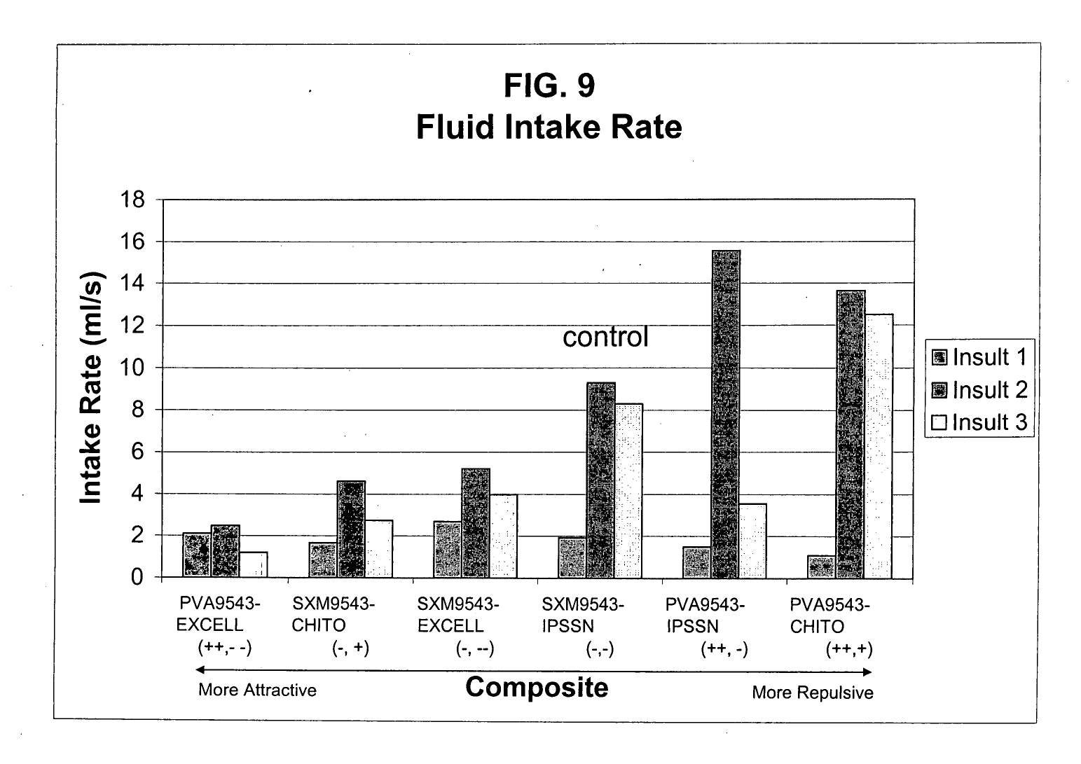

FIG. 9 demonstrates the fluid intake rate versus composite component surface charge after each of three fluid insults. It can be seen that the repulsive forces produced from the CATIOFAST coated SAP/Chitosan treated fluff combination resulted in the highest overall degree of fluid intake after the third fluid insult.

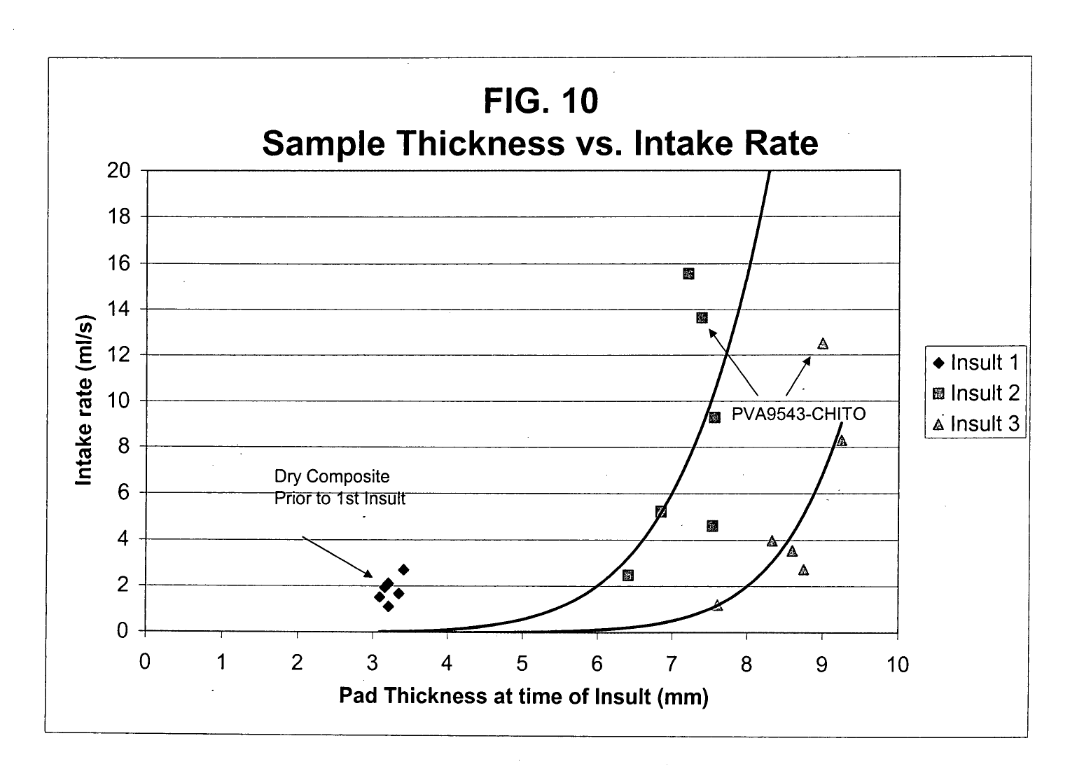

FIG. 10 demonstrates that pads which swell to a greater overall thickness have correspondingly faster fluid intake rates. The highest rates were obtained for CATIOFAST coated SAP/Chitosan treated fluff combinations which also had the greatest wet swelled pad thickness. Thus, a higher swelled thickness is primarily due to a greater volume of interstitial voids (i.e., the open areas available to flow between the solid and liquid fractions of the pad). This is especially evident in the third insult.

It will be appreciated that details of the foregoing examples, given for purposes of illustration, are not to be construed as limiting the scope of this invention. Although only a few examples of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description shall be interpreted as illustrative and not in a limiting sense.

1. An absorbent composite that exhibits an improved fluid intake rate, wherein the components of said composite are treated to have surface charges which create repulsive forces between said composite components upon fluid insult of said composite.

2. The composite of claim 1 wherein said composite components comprise fluff fibers only, superabsorbent particles only, or combination thereof.

3. The composite of claim 1 wherein said treatment is a coating, chemical, electron beam, radiation, corona treatment, or combination thereof.

4. The composite of claim 1 wherein said treatment is same for all components.

5. The composite of claim 1 wherein said treatment is different for all components.

6. The composite of claim 1 wherein said repulsive force is between superabsorbent particles only, fluff fibers only, superabsorbent particles and fibers, or combinations thereof.

7. The composite of claim 1 wherein said composite has an increased void volume.

8. The composite of claim 1 wherein said composite has increased flow channels.

9. The composite of claim 1 wherein said composite has and increased permeability.

10. The composite of claim 1 wherein said composite has an increased swelling thickness.

11. The composite of claim 1 wherein said composite components comprise at least one type of fiber having a complimentary charge to at least one SAP within said composite that provides a desired repulsive property without treatment of said at least one type of fiber.

12. The composite of claim 1 wherein said composite components comprise at least one SAP having a complimentary charge to at least one type of fiber within said composite that provides a repulsive property without treatment of said at least one SAP.

13. The composite of claim 1 wherein said components comprise at least superabsorbent particles in the 300 to 600 microns size range.

14. The composite of claim 1 wherein said components comprise at least superabsorbent particles, and wherein at least 50 percent of said particles are in the 300 to 600 micron size range.

15. The composite of claim 1 wherein said components having said repulsive forces are selectively segregated within said composite.

16. The composite of claim 15 wherein said segregated components are disposed in at lease one discrete layer, strip, section, or combination thereof in said composite.

17. A disposable absorbent article comprising the composite of claim 1.

18. The article of claim 17 wherein said composite is selectively segregated within said composite.

19. The article of claim 17 wherein said composite is in the form of at least one discrete layer, strip, section, or combination thereof in said article.

20. A method of making an absorbent composite comprises treating at least one component of said composite to produce a repulsive force within said composite to increase the void volume of said composite.

21. A method of making an absorbent composite comprises treating at least one component of said composite to produce a repulsive force within said composite to increase the fluid intake rate of said composite.

22. The method of claim 21 wherein said composite components comprise fluff fibers only, superabsorbent particles only, or combination thereof.

23. The method of claim 21 wherein said treatment is a coating, chemical, electron beam, radiation, corona treatment, or combination thereof.

24. The method of claim 21 wherein said treatment is same for all components.

25. The method of claim 21 wherein said treatment is different for all components.

26. The method of claim 21 wherein said repulsive force is between superabsorbent particles only, fluff fibers only, superabsorbent particles and fibers, or combinations thereof.

27. The method of claim 21 wherein said composite has an increased void volume.

28. The method of claim 21 wherein said composite has and increased permeability.

29. The method of claim 21 wherein said composite has an increased swelling thickness.

30. The method of claim 21 wherein said composite components comprise at least one type of fiber having a complimentary charge to at least one SAP within said composite that provides a desired repulsive property without treatment of said at least one type of fiber.

31. The method of claim 21 wherein said composite components comprise at least one SAP having a complimentary charge to at least one type of fiber within said composite that provides a desired repulsive property without treatment of said at least one SAP.

32. The method of claim 21 wherein said components comprise at least superabsorbent particles in the 300 to 600 microns size range.

33. The method of claim 21 wherein said components comprise at least superabsorbent particles, and wherein at least 50 percent of said particles are in the 300 to 600 micron size range.

34. A means for modifying the surface charge of the components of an absorbent composite so that a repulsive force is generated upon consecutive fluid insults which result in an increased fluid intake rate of said composite.
